(19) United States
(12) Patent Application Publication
(10) Pub. No.: US 2015/0377419 A1
(43) Pub. Date: Dec. 31, 2015

(54) SYSTEM AND METHOD FOR CONTROLLING OPERATION OF LIQUEFIED NATURAL GAS SYSTEM

(71) Applicant: Electro-Motive Diesel, Inc., LaGrange, IL (US)

(72) Inventor: Peter O. Popadiuc, Bensenville, IL (US)

(73) Assignee: Electro-Motive Diesel, Inc., LaGrange, IL (US)

(21) Appl. No.: 14/846,858

(22) Filed: Sep. 7, 2015

(51) Int. Cl. F17C 9/00; F04B 15/08

(52) U.S. Cl. CPC F17C 9/00; F04B 15/08; F04B 2015/081; F17C 2250/03; F17C 2250/0443; F17C 2250/0636

(57) ABSTRACT

A method of controlling a liquefied natural gas system is provided. The method includes providing a first pump in association with a tank. The method includes connecting a second pump downstream of the first pump through a supply line. The method further includes providing a valve assembly in a return line provided downstream of the second pump. The method includes connecting an adjustable restrictor in the return line, the adjustable restrictor positioned downstream of the valve assembly. The method further includes cooling the second pump by operating the valve assembly in an open configuration to fluidly connect the adjustable restrictor and the second pump. The method also includes providing a flow of the liquefied natural gas to the second pump for controlling an operating temperature of the second pump. The method includes selectively operating the adjustable restrictor to control a suction pressure associated with the second pump.

### TECHNICAL FIELD

The present disclosure relates to a system and method of controlling an operation of a liquefied natural gas system, and more particularly the system and method of controlling the operation of the liquefied natural gas system having two pumps provided in a series arrangement.

### BACKGROUND

In dual fuel engines, a combination of natural gas and diesel fuel may be used to power the engine. Such engines have fuel system that supplies natural gas that can be stored at low temperatures in a liquid phase that is liquefied natural gas. During the engine startup a mandatory cool-down procedure of the liquefied natural gas system's components is necessary that can delay the engine start up. The delay may be due to cool down time of fuel pumps and related components of the liquefied natural gas side of the fuel supply system. The cool-down procedure is necessary in order to avoid liquefied natural gas vaporization during the pumps start up and eliminating the risk of pumps' cavitation.

Startup of the engine 100 is preceded by increasing the system restriction using the adjustable restrictor that will decrease the liquefied natural gas flow throughout system but will increase the pressure conveniently moving and repositioning the operating point of the boost pump. Optimizing the pressure/flow supplied by the first pump ones can minimize or even suppress the cool-down time. That-is conditioned by the level of pressure that is above the saturation point of the liquefied natural gas, the temperature of the cryogenic system components, the thermal mass of the system and the heat exchange surface with the ambient atmosphere that determines the heat leak into the system.

U.S. Pat. No. 7,010,393, hereinafter the '393 patent, describes controlling of multiple pumps operating in parallel or series. The '393 patent describes a method of using an open-loop response to deal with large transients threatening to force a pump into an operating region that might result in damage or destruction. However, the '393 patent does not describe a system and method to prevent the delay associated with the pumps during startup.

Summary of the Disclosure

In one aspect of the present disclosure, a method of controlling the operation of a liquefied natural gas system is provided. The liquefied natural gas system includes a first pump and a second pump. The first and second pumps are connected in a series arrangement. Further, the first pump is a centrifugal pump and the second pump is a volumetric pump. The method includes providing the first pump in association with a tank. The tank is configured to store a liquefied natural gas. The method also includes connecting the second pump downstream of the first pump through a supply line. The method further includes providing a valve assembly in a return line provided downstream of the second pump. The method includes connecting an adjustable restrictor in the return line, the adjustable restrictor positioned downstream of the valve assembly. The method further includes cooling the second pump. The method includes operating the valve assembly in an open configuration to fluidly connect the adjustable restrictor and the second pump. The method also includes providing a flow of the liquefied natural gas from the tank via the first pump through the supply line towards the second pump. The method further includes selectively operating the adjustable restrictor to control a suction pressure associated with the second pump based, at least in part, on operating point of the boost pump and the static pressure associated with the tank.

Other features and aspects of this disclosure will be apparent from the following description and the accompanying drawings.

### BRIEF DESCRIPTION OF THE DRAWINGS

FIG. 1 is a perspective view of a portion of an exemplary engine system having a high pressure direct injection natural gas system, according to one embodiment of the present disclosure;

FIG. 2 is a schematic view of a liquefied natural gas system, according to one embodiment of the present disclosure and;

FIG. 3 is a flow chart of a method for controlling a liquefied natural gas system, according to one embodiment of the present disclosure.

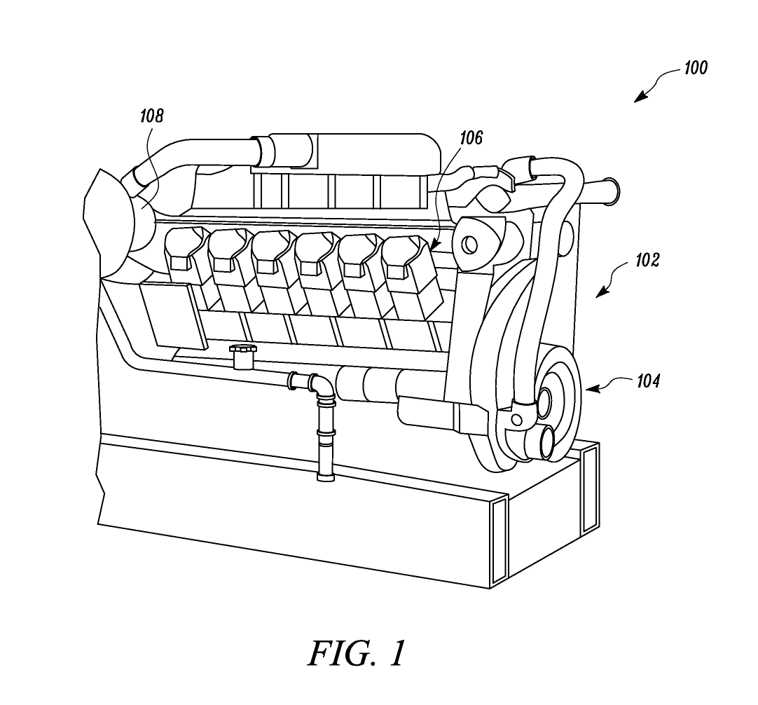

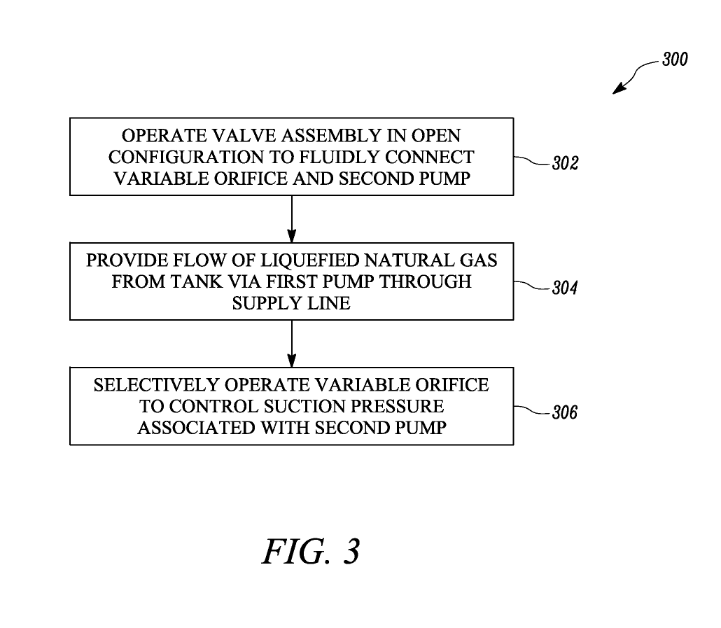

### DETAILED DESCRIPTION

Wherever possible, the same reference numbers will be used throughout the drawings to refer to the same or the like parts. Referring to FIG. 1, an exemplary combustion engine system 100 is illustrated according to one embodiment of the present disclosure. The engine system 100 is embodied as a high pressure of natural gas direct injection system with a diesel pilot engine system 100. In one example, the engine 102 combusts a mixture of air and natural gas at high pressure that is injected directly.

The engine 102 includes an engine block 104 and a cylinder head 106. The engine block 104 includes a plurality of cylinders (not shown). Each of the plurality of cylinders includes a piston (not shown) and a connecting rod (not shown). The engine 102 may be utilized for any suitable application such as on road or off road vehicles, locomotives, marine engines, and stationary applications such as prime mover for electrical power generators or compressors.

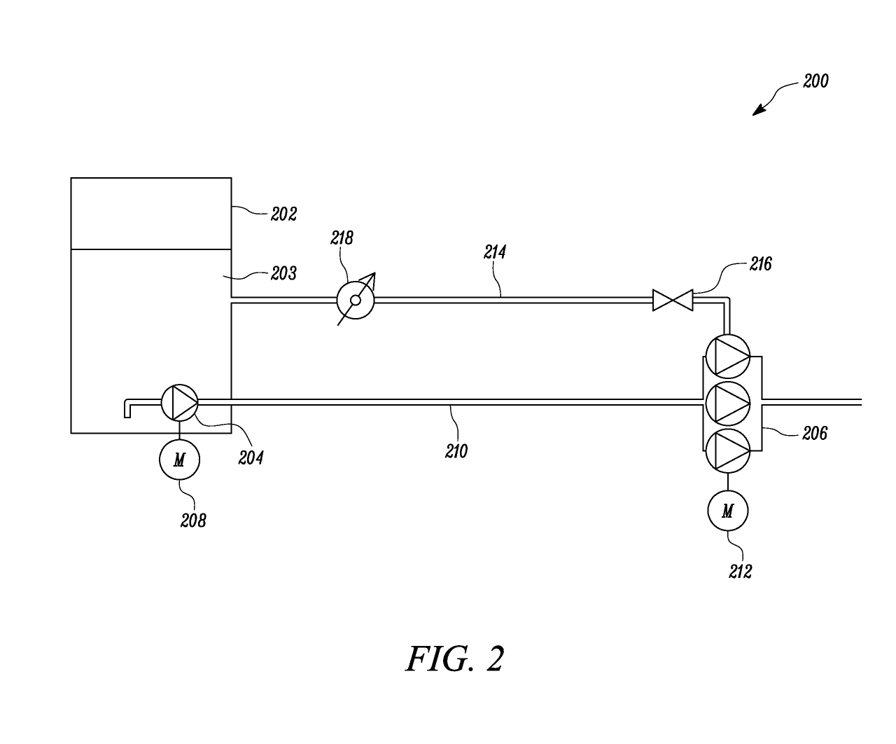

FIG. 2 is a schematic view of a liquefied natural gas system 200. The liquefied natural gas system 200 includes a tank 202. The tank 202 is configured to store liquefied natural gas 203 at a static pressure. In one embodiment, an isolated material or vacuum jacket may be present between an inner wall and an outer wall of the tank 202 in order to maintain a predetermined temperature and pressure “P1” inside the tank 202

The liquefied natural gas system 200 includes a supply line 210. The supply line 210 is in fluid communication with the tank 202. The liquefied natural gas system 200 includes a first pump 204 and a second pump 206. In the present embodiment, the first pump 204 is a boost pump and the second pump 206 is a high pressure pump. The supply line 210 connects the first pump 204 in series arrangement with the second pump 206. The second pump 206 is provided outside the tank 202. The second pump 206 is provided downstream of the first pump 204. The first pump 204 along with the second pump 206 is configured to supply the liquefied natural gas 203 to the engine 102 via a vaporizer and fuel conditioning module (not shown). In an example, the second pump 206 is a combination of three pumping elements arranged in parallel. The two pumps 204, 206 are actuated by actuators 208 and 212 respectively.

The liquefied natural gas system 200 also includes a return line 214. The return line 214 recirculates the liquefied natural gas 203 from the supply line 210 to the tank 202. The return line 214 includes a valve assembly 216 and an adjustable restrictor 218. The valve assembly 216 may be manually or automatically controlled. The adjustable restrictor 218 is configured to control a flow of the liquefied natural gas 203 when the valve assembly 216 is open. More particularly, the adjustable restrictor 218 controls the flow of the liquefied natural gas 203 to control the output parameters of the first pump 204. Further, the output parameters of the first pump 204 may control the pressure within the supply line 210 in order to control the flow rate or vice versa. The adjustable restrictor 218 may be manually or electronically controlled by an external means (not shown). The adjustable restrictor 218 increases an output pressure of the first pump 204 above a certain saturation point of the liquefied natural gas 203. The increase in pressure above the saturation point prevents vapor formation of the liquefied natural gas 203 upstream the second pump 206. Further, prevention of the vapor formation of the liquefied natural gas 203 reduces or completely eliminates the cool-down time of the second pump 206.

At a low flow rate the valve assembly 216 opens and the adjustable restrictor 218 restricts the flow of the liquefied natural gas 203 to the tank 202. The restriction in flow of the liquefied natural gas 203 increases a pressure head at a suction end of the second pump 206. In one example, the pressure head at the suction end increases to a value that is higher than a required Net Positive Suction Head Required (NPSHR) for a wider range or all ranges of operating conditions. The increase in the pressure head at the suction end prevents cavitation or vaporization of the liquefied natural gas 203.

Various embodiments disclosed herein are to be taken in illustrative and explanatory sense, and should in no way be construed as limiting of the present disclosure. All joinder references (e.g., attached, affixed, coupled, engaged, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims

### INDUSTRIAL APPLICABILITY

The present disclosure relates to an engine system 100 that include the high pressure, direct injection natural gas system 200. The liquefied natural gas system 200 includes the adjustable restrictor 218. The adjustable restrictor 218 adds a controlled and predictable restriction to the liquefied natural gas 203 flowing through the return line 214. The restriction causes the suction pressure at the suction end of the second pump 206 to increase.

FIG. 4 is a flowchart for a method 300 for controlling an operation of the liquefied natural gas system 200. At step 302, the valve assembly 216 is operated in the open configuration to fluidly connect the adjustable restrictor 218 to the second pump 206. At step 304 the liquefied natural gas 203 stored in the tank 202 is pumped by the first pump 204 to flow through the supply line 210 towards the second pump 206. The liquefied natural gas 203 then flows through the return line 214, via the valve assembly 216 and the adjustable restrictor 218, back in to the tank 202. During a cool down procedure, the components of the liquefied natural gas system 200 are cooled until a temperature of the components reach an operating temperature. Associating the cool-down process with the pressure control of the return line 214 can reduce and minimize the time required for starting up the second pump 206, and consequently minimize the startup time of the engine 100.

At step 306, the adjustable restrictor 218 is selectively operated to control the suction pressure associated with the second pump 206, based on the flow rate of the liquefied natural gas 203 and the static pressure associated with the tank 202. The restriction created by the adjustable restrictor 218 assists in early startup of the second pump 206, decreasing the overall time delay for engine start up.

While aspects of the present disclosure have been particularly shown and described with reference to the embodiments above, it will be understood by one skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for controlling an operation of a liquefied natural gas system, the liquefied natural gas system including a first pump and a second pump, the first and second pumps connected in a series arrangement, wherein the first pump is a centrifugal pump and the second pump is a volumetric pump, the method comprising:
providing the first pump in association with a tank, the tank configured to store a liquefied natural gas;
connecting the second pump downstream of the first pump through a supply line;
providing a valve assembly in a return line provided downstream of the second pump;
connecting a adjustable restrictor in the return line, the adjustable restrictor positioned downstream of the valve assembly; and
cooling the second pump, wherein the cooling comprises:
operating the valve assembly in an open configuration to fluidly connect the adjustable restrictor and the second pump;
providing a flow of the liquefied natural gas from the tank via the first pump through the supply line towards the second pump for controlling an operating temperature of the second pump; and
selectively operating the adjustable restrictor to control a suction pressure associated with the second pump based, at least in part, on a flow rate of the liquefied natural gas at a static pressure associated with the tank.
